(19) United States
(12) Patent Application Publication
(10) Pub. No.: US 2006/0080230 A1
(43) Pub. Date: Apr. 13, 2006

(54) Method and system for identity theft prevention, detection and victim assistance

(76) Inventor: Steven Freiberg, Jericho, NY (US)

Correspondence Address: KILPATRICK STOCKTON LLP, 607 14TH STREET, N.W., WASHINGTON, DC, 20005, US

(21) Appl. No.: 10/953,591

(22) Filed: Sep. 30, 2004

Related U.S. Application Data
(63) Continuation-in-part of application No. 10/933,261, filed on Sep. 3, 2004.

(51) Int. Cl. G06Q 40/00

(52) U.S. Cl. 705/39

(57) ABSTRACT

A method and system that offers an identity theft prevention/detection service combined with a comprehensive victim assistance program. The identity theft prevention/detection service includes electronically monitoring an account associated with a customer for potential fraudulent activity. During the monitoring, potential fraudulent activity related to the account can be identified using fraud indicators. Once fraudulent activity is determined, the identity of the customer associated with the account can be verified. The verification can be done using information obtained from the customer with information obtained from the account associated with the customer. A credit report can be obtained and reviewed with the customer and a credit specialist. The credit specialist can be associated with a credit bureau or a commercial bureau. After reviewing the credit report, the case specialist can assist the customer in rectifying the fraudulent activity.

### PRIORITY

This application is a continuation in part of, and claims priority to, U.S. patent application Ser. No. 10/933,261, filed Sep. 3, 2004, and also claims priority to U.S. Provisional Patent Application 60/499,378, filed on Sep. 3, 2003. Each of the above-identified applications is incorporated herein by reference in its entirety.

### FIELD OF THE INVENTION

The present invention relates generally to methods and systems for providing assistance to victims dealing with identity theft. More particularly, but not by way of limitation, the present invention includes methods and systems that offer an identity theft prevention/detection service combined with a victim assistance program.

### BACKGROUND

Identity theft is the unauthorized use of personal information such as name, address, social security number, date of birth and mother's maiden name to establish or assume credit under someone else's name. Identity theft manifests itself primarily in two ways: first, as a fraudulent application in which a new credit relationship is established using someone else's personal information; and second, through account takeover in which an existing credit relationship is assumed using someone else's personal information.

Identity theft occurs through various means, for example, through increased availability of information online and elsewhere (mother's maiden name, passwords, etc.), illegal access to credit bureau information, illegal sale of information by trusted sources (governmental agencies, collusive employees, etc.), fraud scams that seek this information directly from consumers, acquaintance/family member who generally has access to a victim's personal information, and theft of information from an unlocked mailbox, stolen purse/wallet or discarded information in the garbage.

Existing processes to assist victims of identity theft are primarily based on an institution's (e.g., a bank's) individual creditor relationship with the victim. Therefore, there are several different systems (even within an institution, such as between a bank's card business and banking business) whereby the victim has to work with different units in order to have his or her identity restored. For example, the victim would contact a particular unit of a bank to close a particular account. The victim is then transferred to another unit for another account, and even to a further unit that would provide victim assistance.

Accordingly, there is a need for a victim assistance method and system that provides victims of identity theft not only the capability of restoring their good name and credit-worthiness on an individual transaction, but also on the basis of their other creditor relationships.

These exemplary embodiments are mentioned not to limit or define the invention, but to provide examples of embodiments of the invention to aid understanding thereof. Exemplary embodiments are discussed in the Detailed Description, and further description of the invention is provided there. Advantages offered by the various embodiments of the present invention may be further understood by examining this specification.

### SUMMARY

Embodiments of the present invention comprise systems and methods for identity theft prevention/detection service combined with a victim assistance program. The identity theft prevention/detection service includes electronically monitoring at least one account associated with a customer for potential fraudulent activity, identifying potential fraudulent activity related to the account based on one or more fraud indicators, verifying identity of the customer associated with the account, and reviewing a credit report with the customer and a credit specialist, wherein the credit specialist is associated with a credit bureau or a commercial bureau. The comprehensive victim assistance program includes assisting the customer to rectify the fraudulent activity.

### BRIEF DESCRIPTION OF THE DRAWINGS

These and other features, aspects, and advantages of the present invention are better understood when the following Detailed Description is read with reference to the accompanying drawings, wherein:

FIG. 1 illustrates a block diagram of a system that offers an identity theft prevention/detection service combined with a victim assistance program in accordance with an exemplary embodiment of the present invention;

FIGS. 2A-2C (“FIG. 2”) illustrate a flow diagram of a method that offers an identity theft prevention/detection service combined with a comprehensive victim assistance program in accordance with an exemplary embodiment of the present invention; and

FIG. 3 illustrates a flow diagram of a method that offers victim assistance to a victim of identity theft by a credit bureau in accordance with an exemplary embodiment of the present invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the invention.

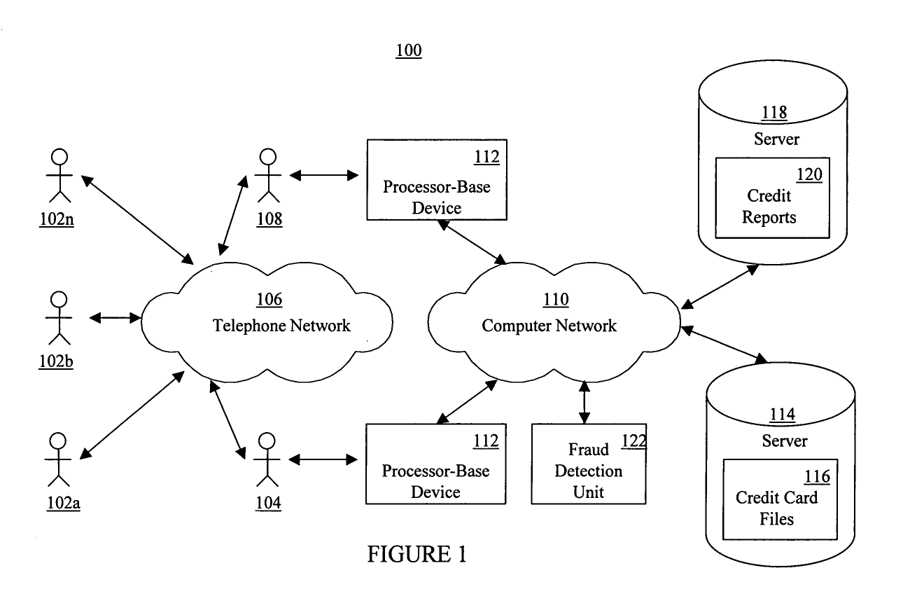

Various systems in accordance with the present invention may be constructed. FIG. 1 is a diagram illustrating an exemplary system in which embodiments of the present invention can operate. The present invention may operate, and be embodied in, other systems as well.

Referring now to the drawings in which like numerals indicate like elements throughout the several figures. FIG. 1 is a block diagram illustrating a system in accordance with an exemplary embodiment of the present invention. The system 100 shown in FIG. 1 includes a telephone network 106 which allows one or more customers 102, e.g., a credit card customer, business card customer, or business customer, to communicate with one or more case specialists 104 and/or one or more representatives e.g., a credit specialist 108, at a credit bureau (e.g., TransUnion) or a commercial bureau (e.g., Dunn & Bradstreet). In one embodiment, the customer 102, the case specialist 104, and credit specialist 108 can participate together in telephone conference via the telephone network 106.

The system 100 includes a computer network 110 which allows the case specialist 104 and the credit specialist 108 to communicate electronically with each other and share access to data. In some embodiments, the computer network 110 comprises the Internet. In other embodiments, other networks, such as an intranet, WAN, or LAN can be used. The case specialist 104 and credit specialist 108 can access the computer network 110 via a processor-based device 112.

The processor-based device 112 can comprise a computer-readable medium, such as a random access memory (RAM) coupled to a processor. The processor executes computer-executable program instructions stored in memory. Such processors may comprise a microprocessor, an ASIC, and state machines. Such processors comprise, or may be in communication with, media, for example computer-readable media, which stores instructions that, when executed by the processor, cause the processor to perform the steps described herein. Embodiments of computer-readable media include, but are not limited to, an electronic, optical, magnetic, or other storage or transmission device capable of providing a processor with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

The processor-based device 112 can also comprise a number of external or internal devices such as a mouse, a CD-ROM, DVD, a keyboard, a display, or other input or output devices. Examples of processor-based devices 112 are personal computers, digital tablets, laptop computers, Internet appliances, and other processor-based devices. In general, a processor-based device 112 can be any type of processor-based platform that is connected to a telephone network 106 or computer network 110 and that interacts with one or more application programs. Processor-based devices 112 can operate on any operating system capable of supporting a browser or browser-enabled application, such as Microsoft® Windows® or Linux.

Through the processor-based device 112, the case specialist 104 can communicate over the computer network 110 with one or more server devices 114, 118. Examples of a server device 114, 118 are servers, mainframe computers, networked computers, a processor-based device, and similar types of systems and devices. The server 114 can contain credit card files 116 (or credit information generally) associated with customers 102. The credit card files 116 can include credit card information, for each credit card, issued by the credit card issuer, and is associated with a customer 102. The credit card files 116 can include such information as transaction information, billing information, billing address, passwords, etc. The case specialist 102 can access the credit card files 116 on the server 114 via the computer network 110. The server 118 can contain one or more credit reports or can generate credit reports 120 associated with a customer 102. The case specialist 104 and/or the credit specialist 108 can access the credit reports 120 on the server 118 via the computer network 110.

The system 100 can include a fraud detection unit 122, e.g., an early fraud warning system, which can monitor at least one credit card account or business card account, associated with a customer 102, for potential fraudulent activity, e.g., suspicious activity. Monitoring suspicious activity can include, but is not limited to, reviewing all transactions, using authorization detection strategies to detect out-of-pattern spending and payments (e.g., multiple charges at the same location or for charges for the same goods, such as gasoline), reviewing changes to a customer's data (e.g., telephone number, mailing address), reviewing new applications filed, reviewing high risk transactions (e.g., involving address change and card request sent to a high risk zip code area or an overnight card request to alternate shipping address located in a high risk zip code area), reviewing high risk client checks requested by creditors and retailers that have a higher fraud rate based on historical details, monitoring Known Fraud Indicator System (KFIS) database records which include fraudulent addresses and phone numbers to see if a customer's data is changed to a fraudulent address or phone number, reviewing balance transfer check requests, investigating an account when a credit inquiry is requested by a collusive credit bureau subscriber, reviewing billing address/ship-to-address mismatch, etc. Monitoring can include monitoring account data changes that match a fraud indicator system, such as the Known Fraud Indicator System (KFIS), and industry data, such as, Issuer Clearing Service (ICS) alerts, and for new accounts, such as, New Account Processing System (NAPS). Monitoring can also be used to identify potential internal collusion and information security compromise issues, and monitoring suspicious applications, transaction activity, balance requests, and high risk requests. Account changes can be verified with the customer. The monitoring can be electronic monitoring or can be done by one or more individuals in conjunction with electronic monitoring. The monitoring services can be free or fee-based.

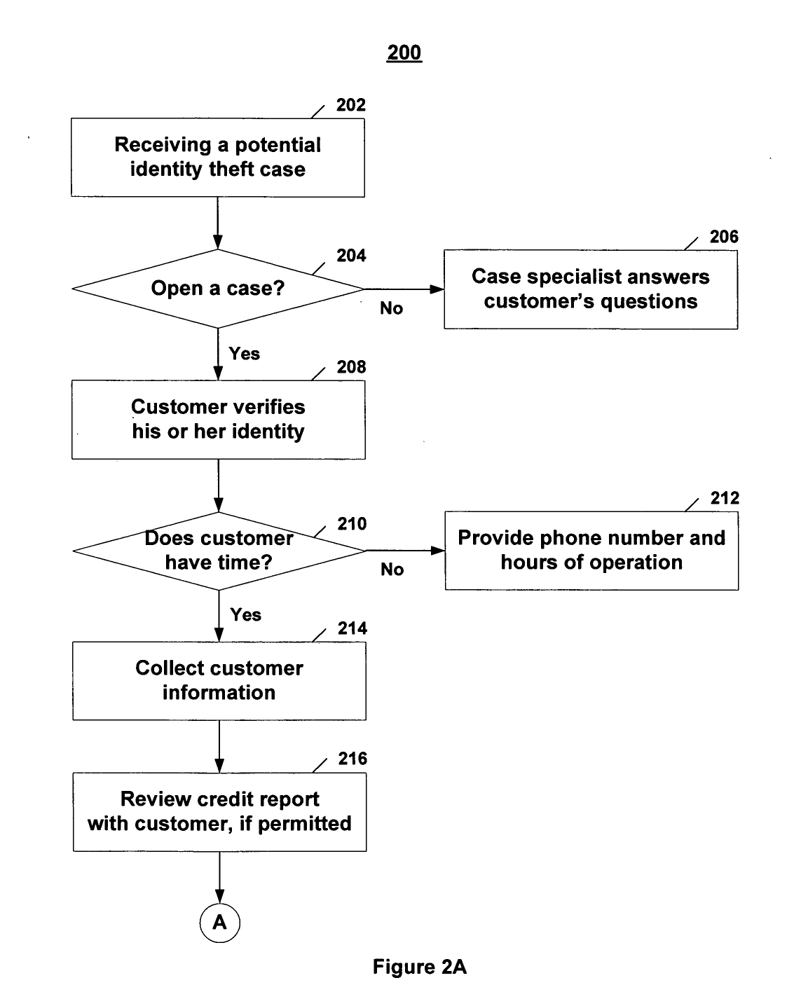

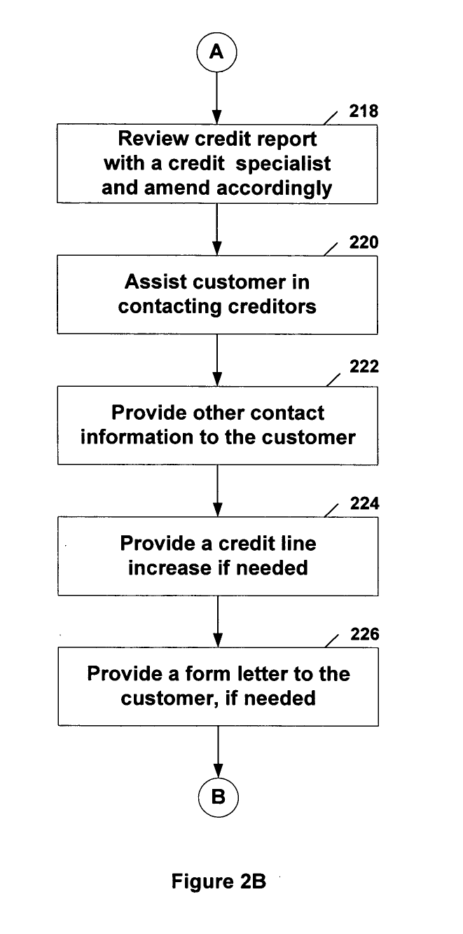

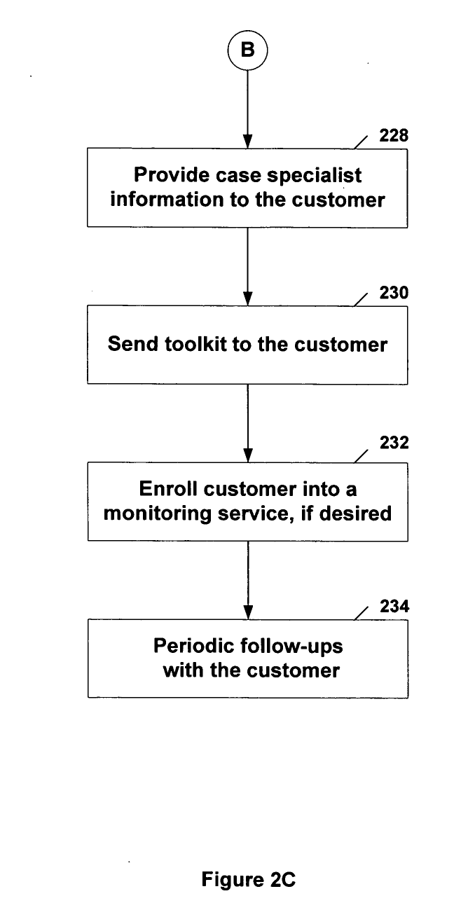

It should be noted that the present invention may comprise systems having different architecture than that which is shown in FIG. 1. For example, in some systems according to the present invention, the server devices 114, 118 can comprise a single physical or logical server. In other embodiments, the server devices 110, 114 can be single servers, a virtual server, multiple servers, etc. The system 100 shown in FIG. 1 is merely exemplary, and is used to help explain the communication network and methods illustrated in FIG. 2. Moreover, methods according to the present invention may operate within a single computer.

FIG. 2 illustrates an exemplary method 200 for assisting a victim of identity theft in accordance with an embodiment of the present invention. This exemplary method is provided by way of example, as there are a variety of ways to carry out methods according to the present invention. The method 200 shown in FIG. 2 can be executed or otherwise performed by one or a combination of various systems. The method 200 is described below as carried out by the system 100 shown in FIG. 2 by way of example, and various elements of the system 100 are referenced in explaining the example method of FIG. 2.

The method 200 illustrated in FIG. 2 begins in block 202 with receiving a potential identity theft case. A case specialist 104 can receive a potential identity theft case from a customer 102, from the fraud detection unit 122, or other known methods. For example, a customer 102 can call a credit card issuer that issued the credit card which may be subject to a potential identity theft case The call can go directly to a case specialist 104 or can come from a customer service representative for the credit card issuer who transfers the call to the case specialist 104.

After receiving the case, the method 200 proceeds to block 204 where a determination is made whether to open a case. The determination can be based on whether the customer 102 meets criteria for being a victim of identity fraud. A case can be established or opened based upon the customer's belief that they may be a victim even if there is no initial proof to substantiate their concern. A case can be opened for a victim who is an existing customer of the card issuer or for a victim whose only relationship with the credit card issuer is through the fraudulent account in question.

If the determination is made that the customer 102 is not a victim of identity theft, then the method 200 proceeds to block 206 where the case specialist 104 can answer any questions that the customer might have about identity theft and/or the case specialist 104 can send the customer a brochure on identity theft.

If the customer 102 meets the criteria, the method 200 proceeds to block 208 where the customer verifies his or her identity. For example, the case specialist 104 can access a file associated with the customer 102, e.g., a credit card file 116 and can verify the customer's identity using information from the customer's file. The customer's identity can be verified through known identity verification methods. If the customer 102 has verified his or her identity earlier in the call, e.g., to a service representative, then the customer identity verification can be skipped. Examples of identity verification can include a customer verifying account passwords or specific information from accounts, social security number origination location (location of issue), verification of a previous address, as well as other known techniques.

After verifying the customer's identity, the method 200 proceeds to block 210 where the case specialist 104 describes the services offered by the card issuer and informs the customer 102 the approximate time required to complete the process. If the customer is interested but does not have time for the initial call the customer, the method 200 can proceed to block 212 where the customer is provided with a phone number and hours of operation for the unit, thus allowing the customer 102 to call back at a better time. When a customer 102 calls back in at a later time, the process can continue at block 208.

If the customer 102 is interested and has enough time, the method 200 proceeds to block 214, where the customer information is collected. For example, the customer specialist 104 obtains information from the customer, such as, customer contact information (mailing address, home telephone number, work telephone number, and/or mobile telephone number, fraud account information and customer date of birth. The customer information can be saved, e.g., on the server 114. A true password (a non mother's maiden name password) can be obtained from the client and established for the customer 102. A password hint can also be obtained and established.

After collecting customer information, the method 200 proceeds to block 216, where a credit report for the customer 102 is reviewed, if permitted. For example, if a credit relationship exists, e.g., where the customer knowingly established such a relationship, the case specialist 104 accesses an on-line credit report 120. The customer 102 and case specialist 104 review the credit report together. For example, the customer 102 and case specialist 104 can review new accounts, addresses and inquiries from the past 12 months to ensure that the bureau data is correct. The case specialist 104 can record any information that the customer 102 denies as being accurate, e.g., discrepancies.

After reviewing the credit report with the customer, the method 200 proceeds to block 218 where a telephone conference between the customer 102, the case specialist 104 and a credit specialist 108 is conducted and the credit report is amended, if permitted. For example, the case specialist 104 establishes a three way call with a credit specialist 108 from a credit bureau, e.g., TransUnion, or from a commercial bureau, e.g., Dunn & Bradstreet. This can be accomplished using an established relationship and a dedicated phone line, e.g., dedicated phone number. Preferably, no voice recognition unit (VRU) is used, nor waiting and the transition to bringing the credit bureau online into the process is seamless for the customer.

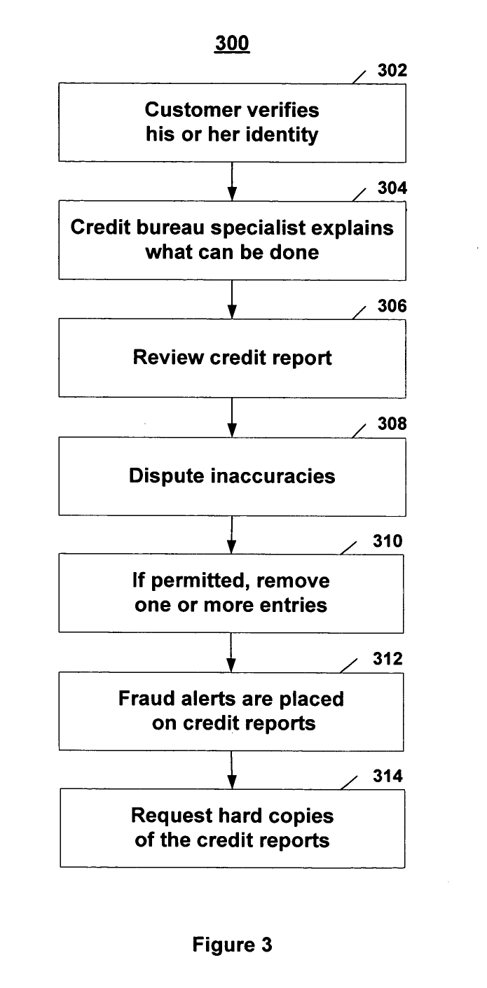

FIG. 3 illustrates an exemplary method 300 for a credit bureau to assist a victim of identity theft in accordance with an embodiment of the present invention. This exemplary method is provided by way of example, as there are a variety of ways to carry out methods according to the present invention. The method 300 shown in FIG. 3 can be executed or otherwise performed by one or a combination of various systems. The method 300 is described below as carried out partially by the system 100 shown in FIG. 1 by way of example, and various elements of the system 100 are referenced in explaining the exemplary method of FIG. 3.

The method 300 illustrated in FIG. 3 begins in block 302 with the customer's identity being verified. For example, the credit specialist 108 can verify the customer's identity using a credit report 120. For example, the credit specialist 108 can access a credit report 120 associated with the customer 102 and can verify the customer's identity using information from the credit report 120. The customer's identity can be verified through known identity verification

After verifying the customer's identity, the method 300 proceeds to block 304 where the credit specialist 108 can explain what will be done on the call and how it can affect the customer's credit report 120. After explaining what can be done, the method 300 proceeds to block 306 where a review of the credit report can be performed by the credit report specialist 108, the case specialist 104, and the customer 102. This review can cover a specified time period, e.g., a 12-month period. After reviewing the credit report, the method 300 proceeds to block 308 where inaccuracies can be disputed, e.g., disputed trades, inquiries and addresses can be placed into dispute with the credit bureau. After inaccuracies are recorded, the method 300 proceeds to block 310 where one or more items can be removed from the credit report, if permitted. After removing one or more items, the method 300 proceeds to block 312 where one or more fraud alerts can be placed on the customer's credit report 120. The fraud alerts can be shared with the other credit bureaus. When the customer is the victim of a fraudulent application the fraud alert can last for given period of time, e.g., seven (7) years and can last for a given period of time, e.g., one (1) year for all other types of fraud.

After sharing the fraud alerts with other credit bureaus, the method 300 proceeds to block 314 where at least one hard copy of the credit report to be sent to the customer 102 is requested. In one embodiment, if the address on file for the customer 102 is the same as the address being reported by the customer over the phone, each credit bureau can send a credit report to the victim at that address. If the address does not match, the credit bureau can send the customer a letter requesting additional written verification of the address provided by the customer over the phone prior to sending a hard copy of the credit report.

Referring to FIG. 2 again, after the telephone conference, the method 200 proceeds to block 220 where the customer 102 is assisted in contacting creditors. For example, the case specialist 104 can assist the customer 102 in contacting creditors to initiate an account closure and investigation if the customer 102 has identified fraudulent inquiries or accounts reported on the customer's credit report 120. If needed, new credit cards can be requested. If needed, a power of attorney can be established. The case specialist 104 can then interact with creditors on behalf of the customer 102.

After contacting creditors, the method 200 proceeds to block 222 where the customer 102 is provided with other contact information. For example, the case specialist 104 can explain to the customer 102 how to contact government agencies (e.g. Division of Motor Vehicles), law enforcement (e.g., police in order to file a police report) and any other party needed to resolve the disputed information.

After providing additional information, the method 200 proceeds to block 224 where a temporary credit line increase can be arranged to assist the customer with emergency and necessary purchases while his or her account is being investigated, if needed.

After establishing a temporary credit line increase, the method 200 proceeds to block 226 where a form letter can be provided to the customer for creditors such as mortgage companies. The form letter indicating that one or more credit card accounts are currently being investigated for fraud. This can be useful when the customer 102 is in the process of obtaining new line of credit.

After providing the form letter to the customer 102, the method 200 proceeds to block 228 where the customer 102 can be provided with the contact information and the hours of operation for the case specialist 104 handling the identity theft case.

After providing information relating to the case specialist 104, the method 200 proceeds to block 230 where a customized toolkit can be created and sent to the customer 102. The toolkit can contain a summary of the initial conversation, the contact information of the dedicated case specialist 104, a worksheet detailing the status of their case, impacted creditors and their contact information as well as other useful resources and their contact information such as government and law enforcement agencies. The kit can also contain a universal affidavit of fraud that can be sent back to creditors and a business return envelope for the customer 102 to send the affidavit and supporting materials back to the case specialist 104.

After sending the toolkit, the method 200 proceeds to block 232 where one or more credit card accounts associated with the customer 102 can be enrolled into a credit bureau monitoring service, if permitted. If a new trade, inquiry or address appears on the credit file of the dedicated credit bureau, an electronic notification can be sent to the case specialist 102. The case specialist 102 can then verify the information with the customer 102.

After enrolling the customer 102 into a monitoring service, the method 200 can proceed to block 234 where the case specialist 104 can follow up with the customer periodically throughout the case. For example, the case specialist 104 can follow up with the customer 102 at the following intervals: (a) 14 days to ensure the receipt of the toolkit and bureaus; (b) 60 days to check on the status of account investigations and bureau resolution; and (c) 90 days to close the case if identity fraud issues have been resolved and no new disputed alerts are being received through the alert service.

The method and system described above, enables a victim of identity theft to receive assistance to address the theft by using, preferably, a single case specialist 104 acting with or on behalf of the customer thus making it easier for the customer to recover from an identity theft incident. Additionally, this reduces the need for the customer to repeatedly explain his or her situation.

Embodiments of the present invention have now been described in fulfillment of the above objects. It will be appreciated that these examples are merely illustrative of the invention. Many variations and modifications will be apparent those skilled in the art.

That which is claimed:

1. A method comprising:
electronically monitoring at least one account associated with a customer for potential fraudulent activity;
identifying potential fraudulent activity related to the account based on one or more fraud indicators;
verifying identity of the customer associated with the account;
reviewing a credit report with the customer and a credit specialist, wherein the credit specialist is associated with a credit bureau or a commercial bureau; and
assisting the customer to rectify the fraudulent activity.

2. The method of claim 1 wherein identifying potential fraudulent activity based on one or more fraud indicators comprises the use of a fraud scoring system.

3. The method of claim 1 wherein the one or more fraud indicators are indicators from one of a Known Fraud Indicator System (KFIS) and at least one Issuer Clearing Service (ICS) alert.

4. The method of claim 1 wherein electronically monitoring comprises comparing known fraudulent addresses in a Known Fraud Indicator System (KFIS) database with an address in a new application filed on behalf of a customer.

5. The method of claim 1 wherein electronically monitoring comprises comparing known fraudulent telephone numbers in a Known Fraud Indicator System (KFIS) database with a telephone number in a new application filed on behalf of a customer.

6. The method of claim 1 wherein electronically monitoring at least one account for potential fraudulent activity comprises monitoring for at least one of internal collusion, transaction activity, high risk requests, account changes, balance transfer check request, credit, collusive credit bureau inquiries, billing address and shipping address mismatches, and store applications from high risk stores.

7. The method of claim 1 wherein verifying identity of the customer associated with the account comprises accessing the account associated with the customer and verifying information from the customer with specific information in the account.

8. The method of claim 1 wherein assisting the customer to rectify the fraudulent activity comprises recording discrepancies in the credit report.

9. The method of claim 1 wherein assisting the customer to rectify the fraudulent activity comprises removing discrepancies in the credit report.

10. The method of claim 1 wherein assisting the customer to rectify the fraudulent activity comprises assisting the customer in contacting creditors.

11. A system for mitigating the effects of identity theft, the system comprising:
a fraud detection unit configured to electronically monitor at least one account associated with a customer for potential fraudulent activity using one or more fraud indicators;
a telephone network configured to allow communication between the customer and a case specialist; and
a computer network configured to provide access to account information associated with the customer and access to a credit report associated with the customer, wherein the case specialist verifies identify of the customer using the account information, reviews the credit report with the customer and a credit specialist via the telephone network, and assists the customer to rectify the fraudulent activity.

12. The system of claim 11 wherein the credit specialist is associated with a credit bureau or a commercial bureau.

13. The system of claim 11 wherein the one or more fraud indicators are indicators from one of a Known Fraud Indicator System (KFIS) and at least one Issuer Clearing Service (ICS) alert.

14. The system of claim 11 wherein electronically monitoring comprises comparing known fraudulent addresses in a Known Fraud Indicator System (KFIS) database with an address in a new application filed on behalf of a customer.

15. The system of claim 11 wherein electronically monitoring comprises comparing known fraudulent telephone numbers in a Known Fraud Indicator System (KFIS) database with a telephone number in a new application filed on behalf of a customer.

16. The system of claim 11 wherein electronically monitoring at least one account for potential fraudulent activity comprises monitoring for at least one of internal collusion, transaction activity, high risk requests, account changes, balance transfer check request, credit, collusive credit bureau inquiries, billing address and shipping address mismatches, and store applications from high risk stores.

17. The system of claim 11 wherein verifying identity of the customer associated with the account comprises accessing the account associated with the customer and verifying information from the customer with specific information in the account.
